(19) United States
(12) Patent Application Publication
(10) Pub. No.: US 2010/0053008 A1
(43) Pub. Date: Mar. 4, 2010

(54) ANTENNA HAVING DISTRIBUTED PHASE SHIFT MECHANISM

(75) Inventors: Kevin T. Le, Bloomingdale, IL (US); Francisco X. Gomez, Winfield, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: PC-TEL, Inc., Bloomingdale, IL (US)

(21) Appl. No.: 12/546,478

(22) Filed: Aug. 24, 2009

Related U.S. Application Data
(60) Provisional application No. 61/092,229, filed on Aug. 27, 2008.

(51) Int. Cl. H01Q 9/00; H01Q 1/38

(52) U.S. Cl. 343/745; 343/700 MS

(57) ABSTRACT

An antenna is provided. The antenna includes a first antenna element disposed over a ground plane and a second and third antenna element over the ground plane on opposing sides of the first antenna element, said first, second and third antenna elements forming a linear antenna array. The antenna further includes an electrical delay line having first and second conductors extending between the first and second antenna elements and between the first and third antenna elements, a parallel conductive elements disposed in series with each of the first and second conductors, the conductive elements extending away from the first and second conductors in a single direction perpendicular to a predominant axis of the linear array, a tuning substrate extending across the conductive elements of each of the delay lines with a pair of U-shaped conductive elements on opposing ends of the tuning substrate with opposing arms of each of the U-shaped tuning elements capacitively engaging respective, corresponding portions of the tuning stubs of the first and second conductors in a substantially identical manner and an actuator system that advances the tuning substrates transverse to the predominant axis thereby increasing an electrical delay on the second antenna and decreasing the electrical delay of the third antenna by substantially equal values.

### CROSS REFERENCE TO RELATED APPLICATIONS

This application is a continuation-in-part of U.S. Provisional Patent Application No. 61/092,229 filed on Aug. 27, 2008 and incorporated herein by reference.

### FIELD OF THE INVENTION

The field of the invention relates to antenna arrays and more particularly to the phase shifting of signals from such arrays.

### BACKGROUND OF THE INVENTION

Antenna arrays used for wireless communication systems are well known. Such arrays may be used in any of a number of different types of systems (e.g., cellular communication networks, WiFi, etc.).

One of the important features of known wireless systems is the ability to provide seamless coverage. For example, users of cellular telephones traveling in automobiles would find it irritating to frequently lose call connections (e.g., have the call drop-out) during use. This problem was once wide-spread, but has become less of a problem due to advances in wireless technology.

In order to avoid drop-out, it is necessary for cellular base stations to provide uniform coverage over an area of use (i.e., a service area). However, it is not always possible to achieve uniform coverage. For example, while providing uniform coverage is relatively simple in flat terrain with few buildings, it becomes more complex on hilly terrain or where buildings may block the signal. Moreover, locations that may be optimal for signal propagation may be in private hands and the owners may find the appearance of an antenna to be objectionable and may not allow antenna to be placed in the best locations.

Because of the compromises that may be required in antenna placement, it is often necessary to adjust antenna directivity and placement to the conditions of the location of use. For example, in the case of high-rise buildings, it may be necessary to place several antenna around the high rise with the high-rises located along a periphery of coverage of each antenna. It may also be necessary to adjust the radiation patterns of the wireless base sites. In some cases, this can mean aligning the azimuth and elevation of the various antenna arrays to accommodate the conditions of the area of use. While such processes are effective, they are also labor intensive. Accordingly, a need exists for better methods of adjusting radiation patterns of antenna to the location of use.

### SUMMARY

Existing phase adjustment devices rely upon the use of a centralized phase shifting device including a wiper that pivots around a central location and that has a set of semicircular conductors equal to the number of phase change elements and that uses the feed cable as the feed network. This arrangement results in significant phase errors. Such devices are expensive to make and not very reliable. Moreover, there is a limit to the amount of phase shift that can be achieved by such devices.

Under illustrated embodiments, the antenna is shown with multiple phase shift stages integrated into and distributed along a single printed circuit board (PCB). Each of the phase shift stages can potentially feed a subsequent phase shift stage.

The antenna is very repeatable and has a very robust design. The simple but elegant design provides a wide range of available phase shift that is not limited by a phase scan angle.

The design has a great deal of flexibility for chosen frequencies. The sophisticated nature of the phase shift mechanism allows for scaling of the phase shift to accommodate virtually any frequency. The flexibility allows for elevation electrical downtilt and azimuth beam steering applications.

Illustrated embodiments of the present invention achieve technical advantage by providing a variable elevation beam tilt dual polarized antenna having distributed phase shift elements.

The antenna array design is simple yet sophisticated. The series feed network and distributed phase shifting may be extended to any size without introducing phase error and mismatches due to connections.

The series phase shifter allows great flexibility for circuit design to maximize the dielectric loss which can achieve high gain with respect to antenna length.

In one embodiment, each phase shifter contains two U-shaped conductive elements to produce phase delay for each polarizing tier.

### BRIEF DESCRIPTION OF THE DRAWINGS

FIG. 1 depicts an antenna array with adjustable down tilt in accordance with an illustrated embodiment of the invention;

FIG. 2 depicts the antenna of the array of FIG. 1;

FIG. 3 depicts a simplified diagram of phase adjusting devices that may be used with the antenna array of FIG. 1;

FIG. 4 depicts a rack and pinion adjusting system that may be used with the system of FIG. 1;

FIG. 5 depicts a control handle that may be used with the system of FIG. 1;

FIG. 6 depicts the antenna array of FIG. 1 under an alternate embodiment;

FIG. 7 depicts cumulative phase shift changes by antenna position;

FIG. 8 depicts the antenna of FIG. 1 using an alternative method of phase adjustment; and

FIG. 9 depicts motor detail of the antenna of FIG. 8.

### DETAILED DESCRIPTION OF AN ILLUSTRATED EMBODIMENT

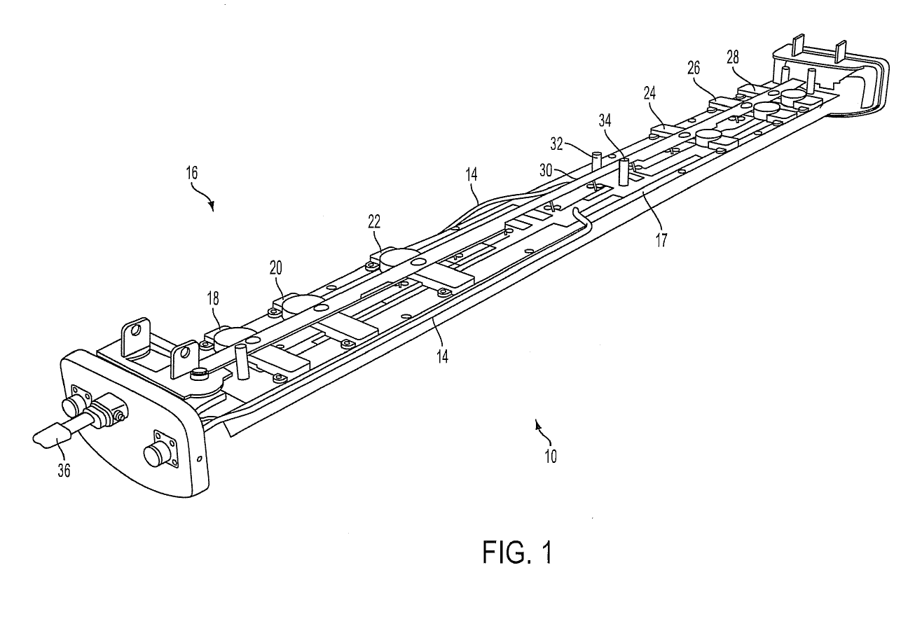

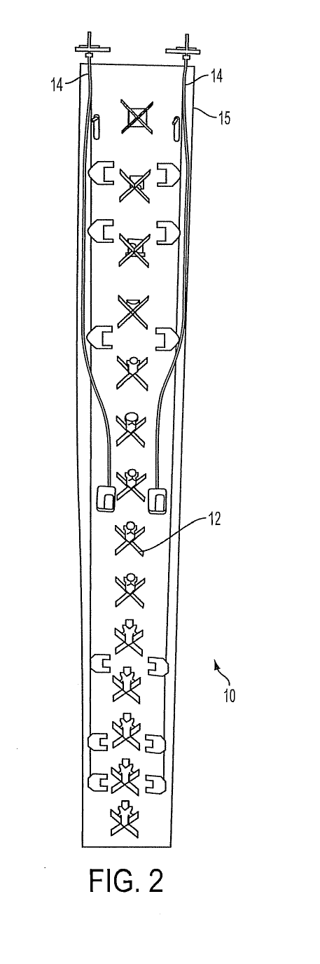

FIG. 1 is a perspective side view of an antenna 10 with adjustable downtilt shown generally in accordance with an illustrated embodiment of the invention. FIG. 2 is a front view of the antenna 10 of FIG. 1 with a protective radome removed. As shown in FIG. 2, the antenna 10 has a length of approximately 48 inches with 14 antenna elements 12 that together form an antenna array over a ground plane 15. The antenna array 10 may be coupled to a transceiver through conductors 14. The antenna 10 and transceiver may operate to couple a radio frequency signal modulated with an information signal at an appropriate transmission frequency (e.g., 3.3-3.8 MHz) between a base station and one or more of an appropriate class of wireless device (e.g., iPhones, personal computers, etc.).

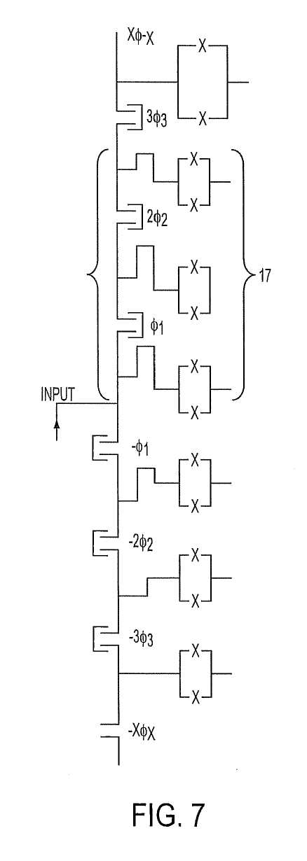

The downtilt of the antenna 10 may be controlled via an actuator system (e.g., a rack and pinion system) 16 coupled to a number of phase shifting devices 18, 20, 22, 24, 26, 28 disposed on and integrated a printed circuit board or base substrate 17. Under one into illustrated embodiment, the phase shifting devices 18, 20, 22, 24, 26, 28 are used in pairs. For example, a pair of phase shifting devices 22, 24 may be used together (as shown schematically in FIG. 7) where the first phase shifting device 22 provides a first positive phase shift θ and the corresponding phase shifter 24 provide a substantially equal amount of negative phase shift θ. Similarly, second pair of phase shifting devices 20, 26 may be used together where a third phase shifting device 20 provides a positive phase shift 2θ and a fourth phase shifting device 26 provides a negative phase shift 2θ. Finally, a third pair of phase shifting devices 18, 28 may be used together where a fifth phase shifting device 18 provides a positive phase shift 3θ and a sixth phase shifting device 28 provides a negative phase shift 3θ.

As shown in FIG. 7, the phase shift of each phase shift stage is cumulative (i.e., connected serially). That is, the phase shift added to the antenna elements on opposing sides of the reference center antenna element is progressively added to the phase shift of subsequent phase shift stages. While only three phase shift stages are shown in FIG. 7, the concept can be extended to achieve virtually any degree of down tilt or beam steering.

The phase shifting devices 18, 20, 22, 24, 26, 28 are coupled to a set of respective antenna elements and adjusted to accomplish the desired downtilt. In this regard, a first antenna element (the seventh and eighth antenna 12 from the bottom in FIG. 2) is coupled to the antenna feed conductors 14 with no (or with only a small amount of fixed) phase delay. The first pair of phase shifting devices 22, 24 are coupled to a second antenna element (the ninth and tenth antenna 12 from the bottom in FIG. 2) and a third antenna element (the fifth and sixth antenna 12 from the bottom in FIG. 2), respectively, on opposing sides of the first antenna element. Similarly, the second pair of phase shifting devices 20, 26 are coupled to a fourth antenna element (the eleventh and twelfth antenna 12 from the bottom in FIG. 2) and a fifth antenna element (the third and fourth antenna 12 from the bottom in FIG. 2), respectively. Finally, the third pair of phase shifting devices 18, 28 are coupled to a sixth antenna element (the thirteenth and fourteenth antenna 12 from the bottom in FIG. 2) and a seventh antenna element (the first and second antenna 12 from the bottom in FIG. 2), respectively.

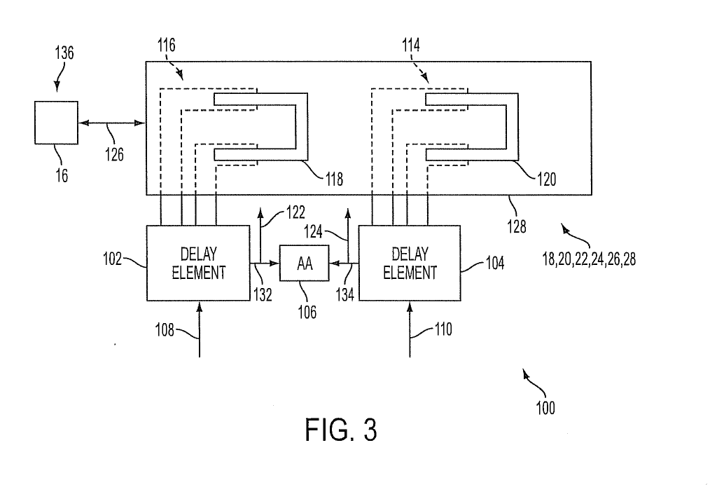

FIG. 3 is a simplified electrical schematic 100 of the antenna 10 depicting operation of each of the phase shifting devices 18, 20, 22, 24, 26, 28. Associated with each of the phase shifting devices 18, 20, 22, 24, 26, 28 is a delay element 102, 104 disposed on the printed circuit board 17. Each of the delay elements 102, 104 may include one or more internal transmission lines and first and second electrically parallel conductive traces 114, 116.

The delay elements 102, 104 receive an input RF signal through a first set of traces 108, 110. The delay elements 102, 104 are, in rum, coupled to respective antenna elements 106 via a second set of conductive traces 132, 134. A third set of conductive traces 122, 124 couple the signal from a previous phase delay subassembly to a subsequent phase delay subassembly.

For example, in the case where the schematic 100 is used to depict one of the first pair of phase delay devices 22, 24, then the inputs 108, 110 would be coupled to the respective RF inputs 14. In this example, the antenna element 106 would be either the second antenna element (the ninth and tenth antenna 12 from the bottom in FIG. 2) or the third antenna element (the fifth and sixth antenna 12 from the bottom in FIG. 2). Similarly, the RF outputs 122, 124 of the first pair of phase delay devices 22, 24 would be connected to the RF inputs 108, 110 of the second pair of phase delay devices 20, 26. The relationship between the second pair of phase shifting devices 20, 26 and the third pair of phase shifting devices 18, 28 would be the same.

Adjustment of each of the delay elements 102, 104 is accomplished via physical movement 126 of a carrier substrate 128 by the actuator system 16. Disposed on the carrier substrate 128 is a first and second U-shaped tuning element (or adjustable delay element) 118, 120 that are each capacitively coupled to a respective parallel conductive traces 114, 116. A spring within the housing can be provided that presses the carrier substrate against the base substrate 17. It should also be noted that changes in phase for different frequencies can be achieved by replacing carrier substrate 128 and U-shaped conductive elements.

As shown in FIG. 3, as the actuator 16 moves 126 the substrate 128 to the right in FIG. 3, the electrical delay imparted to the RF signal, received on inputs 108, 110 and delivered to the antenna element 106, is increased. Similarly, as the actuator 16 moves 126 the substrate 128 to the left in FIG. 3, the electrical delay imparted to the RF signal, received on inputs 108, 110 and delivered to the antenna element 106, is decreased.

The actuator system 16 may include a central rail 30 that simultaneously adjusts each of the phase shifting devices 18, 20, 22, 24, 26, 28. The central rail 30 may be disposed between a set of guides 32, 34 along a length of the antenna 10. A control handle 36 extends through an end of a housing of the antenna 10 for access to and adjustment of downtilt by a technician.

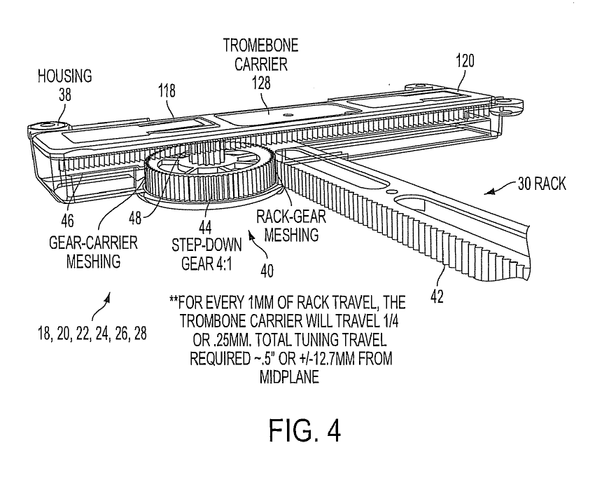

FIG. 4 is a phantom view of one of the phase shifting devices 18, 20, 22, 24, 26, 28 and central rail 30. FIG. 4 shows one of the shifting devices 24, 26, 28 of FIG. 1 turned upside down along with the rail 30. FIG. 4 shows the phase shifting devices 18, 20, 22 as viewed from the far end of FIG. 1.

As shown in FIG. 4, each of the phase shifting devices 18, 20, 22, 24, 26, 28 includes a housing 38, the substrate 128 of FIG. 3 and a step-down gear 40. The phase shifter housing 38, the step down gear 40 and the rack 42 are all made of self lubricating weatherable engineering grade polymers for long term reliability and anti-seizing.

As shown in FIG. 4, the housing 38 has an open bottom to allow the adjustable delay elements 118, 120 of the moveable substrate 128 to be placed is close proximity with the conductive traces 114, 116 on the stationary printed circuit board 17. The adjustable delay elements 118, 120 are coated with a layer of insulating material to such that coupling between the adjustable delay elements 118, 120 and conductive traces 114, 116 is capacitive.

Also carried by the housing 38 is the step down gear 40. In this regard, the housing around the step down gear 40 has an opening near the longitudinal center of the housing 38 that allows a rack 42 of the central rail 30 to engage a large diameter gear portion (pinion) 44 of the step down gear 40.

The step down gear 40 also has a smaller gear portion 48. The smaller gear portion 48 and larger diameter gear portion 44 are rigidly coupled and may form a single gear assembly.

The smaller diameter gear portion 48 forms a pinion that engages a rack 46 on the substrate 128. As the step down gear 40 rotates, the substrate 128 is moved transverse to a longitudinal axis of the antenna 10.

As shown in FIG. 1, the phase shifting devices 18, 20, 22, 24, 26, 28 are tied together by the rail 30 to move simultaneously thereby evenly adjusting each of the 6 bays of the tuning network of the sector antenna 10 of FIG. 1. The step down gear 40 may be provided with a 4:1 step down ratio but this is flexible to accommodate long antenna with more phase shifters. As such, for each millimeter of travel of the central rail 30, the substrate 128 only moves one-quarter of a millimeter.

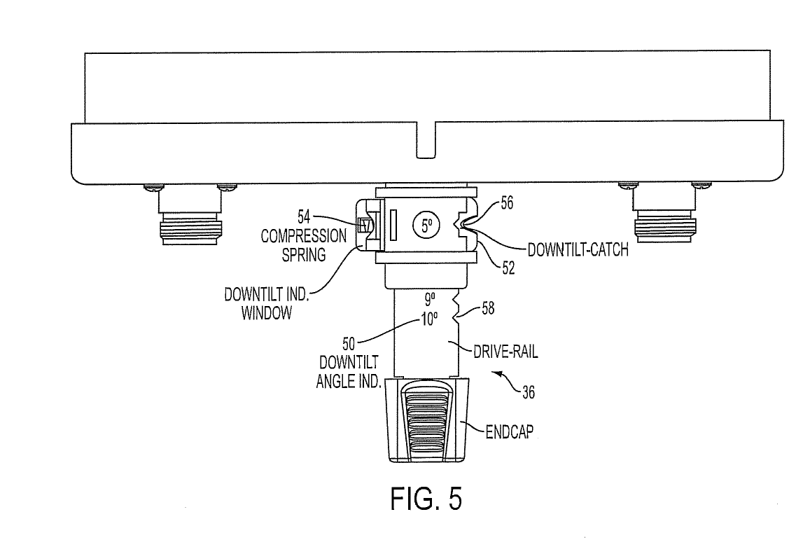

FIG. 5 depicts the external control handle 36. As shown, the control handle 36 may have markings at appropriate intervals with a corresponding level of downtilt provided by that position of the control handle 36. In this regard, a locking clip 52 may be provided to maintain the downtilt in a selected position of the control handle 36. In this regard, the locking clip 52 may be provided with a spring 54 that causes a catch 56 in the locking clip 52 to engage a corresponding notch in the control handle 36 thereby preventing inadvertent movement of the control handle 36 and downtilt except where specifically provided by the technician.

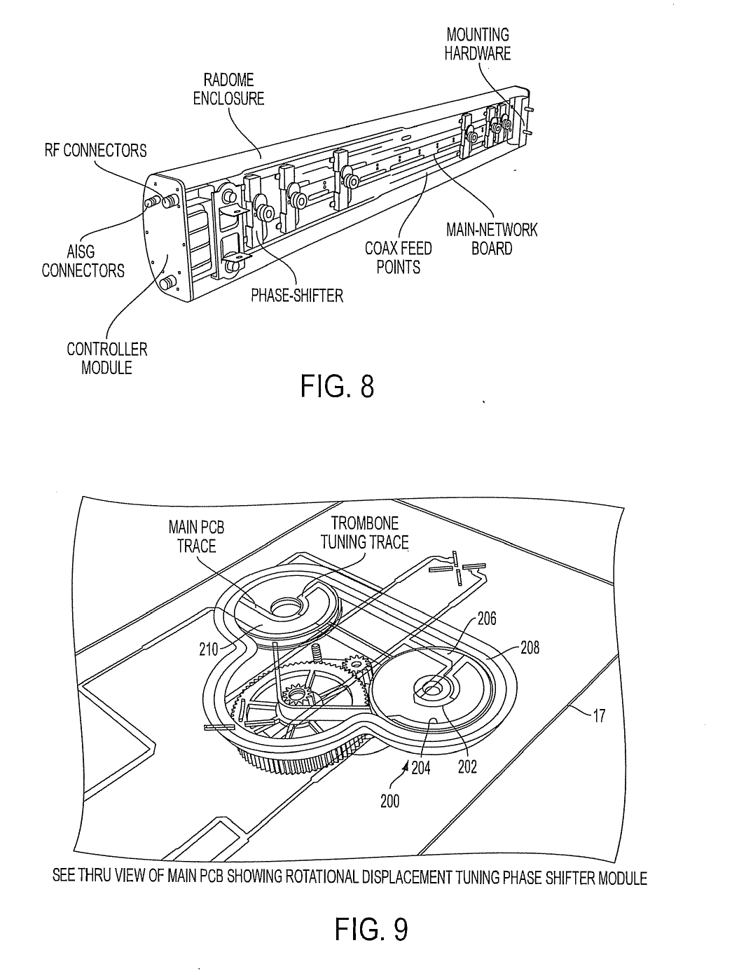

In another illustrated embodiment, the central rail 34 is replaced by an individual motor 136 coupled directly to the gear 40 of each of the phase shifting devices 18, 20, 22, 24, 26, 28 as shown in FIG. 8. In this case, the large diameter portion 44 can be eliminated and where the motor 136 directly drives the small diameter gear 48. The motors 136 may be stepper motors commonly driven from a stepper motor controller to ensure the same amount of simultaneous rotation of each of the gears 48. Alternatively, each motor 136 of a phase shift pair receive the same stepping increment whereas subsequent motors 136 in the phase shift progression receive a greater stepping increment.

In another embodiment shown in FIG. 9, the tuning substrate is replaced with a pair of circular substrates 206, 210. In this case, the parallel traces 202, 204 are curved. Similarly, the opposing arms of the U-shaped conductive element 208 are curved. Under this embodiment, the motor causes the circular substrates 206, 210 to rotate. Rotation in this case causes the opposing arms of the U-shaped tuning element 208 to engage the parallel traces 202, 204.

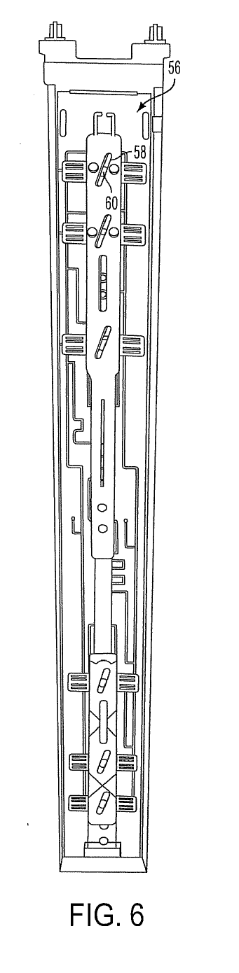

In another illustrated embodiment, the central rail 34 may be replaced by the rail 56 of FIG. 6. In this case, the rack and pinion system is replaced by set of angled slots 58 and cam followers 60. The cam follower 60 is attached to the earner substrate 128. In this case, the movement of the rail 56 causes the cam followers 60 in FIG. 6 to be deflected to the left or right as the rail 56 is moved up and down in FIG. 6 to cause a change in down tilt that is proportional to the amount of movement of the rail 56.

A specific embodiment of a method and apparatus for adjusting the downtilt of a sector antenna has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An antenna comprising:
a first antenna element disposed over a ground plane;
a second and third antenna element over the ground plane on opposing sides of the first antenna element, said first, second and third antenna elements forming a linear antenna array;
a base substrate;
an electrical delay line on the base substrate having first and second conductors extending between the first and second antenna elements and between the first and third antenna elements;
a parallel traces disposed on the base substrate in series with each of the first and second conductors, the conductive traces extending away from the first and second conductors in a single direction perpendicular to a predominant axis of the linear array;
a tuning substrate extending across the conductive traces of each of the delay lines with a pair of U-shaped conductive elements on opposing ends of the tuning substrate with opposing arms of each of the U-shaped conductive elements capacitively engaging respective, corresponding portions of the conductive traces of the first and second conductors in a substantially identical manner; and
an actuator system carried at least in part on the substrate that advances the tuning substrates transverse to the predominant axis thereby increasing an electrical delay on the second antenna and decreasing the electrical delay of the third antenna by substantially equal values, wherein the delay lines, the parallel traces and tuning substrates and actuator system for a single integrated structure.

2. The antenna as in claim 1 wherein the actuator system further comprising a central actuator extending along a length of the linear antenna array parallel to the predominant axis that engages each of the tuning substrates.

3. The antenna of claim 1 further comprising a rack and pinion combination coupling the central actuator to the tuning substrates.

4. The antenna of claim 3 further comprising a rack of the rack and pinion combination extending along a side of the central actuator parallel to the predominant axis.

5. The antenna of claim 4 further comprising a rack of the rack and pinion combination extending along each of the tuning substrates perpendicular to the predominant axis.

6. The antenna of claim 5 further comprising a pinion assembly of the rack and pinion combination that couples the rack of the central actuator to the rack of the tuning substrate.

7. The antenna of claim 6 wherein the pinion assembly further comprises a first and second pinion coupled to a common shaft.

8. The antenna of claim 7 further comprising the first pinion of the pinion assembly engaging the rack of the central actuator and the second pinion of the pinion assembly engaging the tuning substrates.

9. The antenna of claim 8 further comprising the first pinion having a diameter substantially equal to four times a diameter of the second pinion.

10. The antenna of claim 9 further comprising a respective housing that supports each of the tuning substrates and the pinion assembly.

11. An antenna comprising:
an antenna array;
an electrical delay line having first and second conductors extending along a predominant axis of the antenna array between a middle reference antenna element and antenna elements on opposing sides of the middle antenna element;
a pair of conductive element disposed between each antenna element of the antenna array in series with respective first and second conductors;
a tuning substrate extending across each of the pairs of conductive traces of each of the delay lines;
a pair of U-shaped conductive elements on opposing ends of each of the tuning substrate with opposing arms of each of the U-shaped conductive elements arranged parallel to and capacitively coupled to respective, corresponding portions of the conductive elements of the first and second conductors in a substantially identical manner; and
an actuator system that advances the tuning substrates and opposing arms of the U-shaped conductive elements parallel to opposing elements of the conductive elements.

12. The antenna element as in claim 11 further comprising a housing that allows the tuning substrates to be advanced transverse to the predominant axis.

13. The antenna element as in claim 11 further comprising the actuator system arranged to move the tuning substrates in a single direction on both sides of the middle antenna element thereby increasing an electrical delay on a first side of the middle antenna element and decreasing the electrical delay on a second side of the middle antenna element by substantially equal values.

14. The antenna as in claim 11 further comprising the delay lines, the tuning substrates and actuator system cooperating to double the electrical delay between the middle antenna element and each successive antenna element.

15. The antenna as in claim 11 wherein the actuator system further comprising a central actuator extending along a length of the linear antenna array parallel to the predominant axis that engages each of the tuning substrates.

16. The antenna of claim 15 further comprising a rack and pinion combination coupling the central actuator to the tuning substrates and a rack of the rack and pinion combination extending along a side of the central actuator parallel to the predominant axis.

17. The antenna of claim 16 further comprising a rack of the rack and pinion combination extending along each of the tuning substrates perpendicular to the predominant axis that couples the rack of the central actuator to the rack of the tuning substrate.

18. An antenna comprising:
an antenna array;
an electrical delay line having first and second conductors extending along a predominant axis of the antenna array between a middle antenna element and antenna elements on opposing sides of the middle antenna element;
a pairs of conductive elements disposed between each antenna element of the antenna array in series with respective first and second conductors;
a tuning substrate extending across each of the pairs of conductive elements of each of the delay lines;
a pair of U-shaped conductive elements on opposing ends of each of the tuning substrate with opposing arms of each of the U-shaped conductive elements arranged parallel to and capacitively coupled to respective, corresponding portions of the conductive elements of the first and second conductors in a substantially identical manner; and
means for advancing the tuning substrates and opposing arms of the U-shaped conductive elements parallel to opposing elements of the conductive elements.

19. The antenna as in claim 18 wherein the means for actuating further comprising a central actuator extending along a length of the linear antenna array parallel to the predominant axis that engages each of the tuning substrates.

20. The antenna of claim 19 further comprising a rack and pinion combination coupling the central actuator to the tuning substrates and a rack of the rack and pinion combination extending along a side of the central actuator parallel to the predominant axis.

21. The antenna of claim 1 wherein the actuator system further comprises an electric motor mechanically coupled to each of the tuning substrates.

22. The antenna of claim 1 further comprising a spring that urges the tuning substrate against the base substrate.

23. An antenna comprising:
a plurality of antenna elements arranged in an array;
a substrate;
a plurality of phase delay stages integral with the substrate extending outwards from opposing sides of a center antenna element of the array wherein the electrical phase delay is cumulative as the phase delay stages progress outwards from the center antenna element and where an antenna feed is connected to the center antenna element;
an actuator that adjusts the phase delay of each of the phase delay stages.
